(19) United States
(12) Patent Application Publication
(10) Pub. No.: US 2009/0315326 A1
(43) Pub. Date: Dec. 24, 2009

(54) UNIVERSAL INLET ADAPTER

(76) Inventor: Kenneth A. Pieroni, Yorba Linda, CA (US)

Correspondence Address: STETINA BRUNDA GARRED & BRUCKER, 75 ENTERPRISE, SUITE 250, ALISO VIEJO, CA, 92656, US

(21) Appl. No.: 12/144,846

(22) Filed: Jun. 24, 2008

(51) Int. Cl. F16L 35/00

(52) U.S. Cl. 285/328

(57) ABSTRACT

There is provided an inlet adapter for use with a fluid integrity test device for testing a fluid system. The fluid system includes a primary inlet collar defining a primary collar inner periphery. The inlet adapter includes an adapter body having an adapter inlet face and an adapter contact face. The adapter contact face is disposable in contact with the primary inlet collar to form a fluid tight seal with the primary inlet collar. The adapter contact face defines a contact face periphery that is circumscribable about the primary collar inner periphery. An adapter inner wall is disposed about an adapter axis and extends between the adapter inlet face and the adapter contact face to form an adapter channel. The adapter channel is in fluid communication with the fluid system when the fluid tight seal is formed between the adapter contact face and the primary inlet collar.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates generally to a tool used while testing the fluid integrity of a fluid system, and more specifically to an inlet adapter for use with a fluid test device for detecting the presence and location of leaks within the fluid system.

2. Description of the Prior Art

It is understood that routine usage of a fluid system may compromise the fluid integrity thereof. A fluid system may include a fluid reservoir, tank, or any structure designed to store or transport fluid (e.g., automobile gas tank, oil pipeline, etc.). When the fluid integrity of the fluid system is compromised, leaks are likely to develop. Such leaks may be caused by corrosion or a chemical reaction in the walls of the fluid system. Furthermore, persistent vibration within the fluid system may also weaken the integrity of the fluid system making it vulnerable to a fluid leak.

In view of the foregoing, it is desirable to detect the existence and location of fluid leaks as soon as possible. The leaking fluid may be toxic or hazardous, which may cause environmental and/or health related concerns. Furthermore, the leaking fluid may be expensive to replace. For instance, with the rising cost of oil, persistent fuel leaks may be very costly. In addition, the fluid system may be configured to deliver fluid to other systems during normal operation (such as an engine receiving gas from a fuel tank). Therefore, if the fluid system leaks, it may disrupt normal operation of the other dependant systems.

Current methods of fluid leak detection include placing the fluid system under pressure for a predetermined period of time. If the pressure within the system holds, the system is presumed to be fluidly intake. Another method relates to delivering pressurized smoke or colored gas into the fluid system. The fluid system is subsequently inspected for escaping smoke or colored gas. This inspection method may not only identify the existence of a fluid leak, but also the precise location of the leak.

In both of the above-described leak detection techniques, as well as other detection methods, it is generally desirable to form a fluid seal between the fluid system inlet and the testing apparatus. However, the configuration of the fluid system inlets may vary from one fluid system to another. For instance, the size and/or configuration of a gas tank inlet tends to vary from one vehicle to another. More specifically, the gas tank inlet typically includes a collar disposed around the gas tank opening. The diameter of the gas tank collar typically varies from one model of vehicles to another.

Therefore, when testing the fluid integrity of the gas tank, the pressurized gas delivery apparatus typically forms a fluid tight seal around the collar. However, since the collars for different automobiles tend to vary in size, a different pressurized gas delivery apparatus is typically required to test each vehicle.

As is apparent from the foregoing, there is a need in the art for an adapter for use with a fluid test device for testing the fluid integrity of a fluid system. The present invention addresses this particular need, as will be discussed in more detail below.

### BRIEF SUMMARY

There is provided an inlet adapter for use with a fluid test device for testing the fluid integrity of a fluid system. The fluid system includes a primary inlet collar defining a primary collar inner periphery. The inlet adapter includes an adapter body having an adapter inlet face and an adapter contact face. The adapter contact face is disposable in contact with the primary inlet collar to form a fluid tight seal with the primary inlet collar. The adapter contact face defines a contact face periphery that is circumscribable about the primary collar inner periphery. An adapter inner wall is disposed about an adapter axis and extends between the adapter inlet face and the adapter contact face to form an adapter channel. The adapter channel is in fluid communication with the fluid system when the fluid tight seal is formed between the adapter contact face and the primary inlet collar.

The inlet adapter may be used with a variety of fluid systems having inlets defining various shapes and sizes. For instance, the contact face periphery of the inlet adapter may be circumscribable about the primary collar inner periphery of various primary inlet collars. In this manner, the inlet adapter may be universal in nature and used to test multiple fluid systems. Therefore, an inlet adapter specifically configured for a particular primary inlet collar may not be required.

The inlet adapter may include various structural attributes configured to enhance the engagement between the inlet adapter and the primary inlet collar, which typically results in a tighter fluid seal between the adapter contact face and the primary inlet collar and may yield better test results. For instance, the inlet adapter may include a magnet connected to the adapter body. The magnet may be magnetically attractable to the primary inlet collar to bias the adapter contact face into fluid tight engagement with the primary inlet collar. The inlet adapter may also include an adhesive disposed on the adapter contact face for securing contact between the adapter contact face and the primary inlet collar.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross sectional view of an embodiment of an inlet adapter configured to create a fluid tight seal between a fluid test device and a fluid system, the inlet adapter having a contact face defining a contact face periphery being circumscribable about a primary collar inner periphery;

FIG. 1A is a cross sectional view of another embodiment of an inlet adapter having an auxiliary inlet channel and an auxiliary outlet channel;

FIG. 2 is a cross sectional view of a further embodiment of an inlet adapter having an adapter sleeve being disposable about a primary collar outer wall;

FIG. 3 is a side elevation view of the inlet adapter shown in FIG. 1; and

FIG. 4 is a lower elevation view of the inlet adapter shown in FIG. 3.

### DETAILED DESCRIPTION

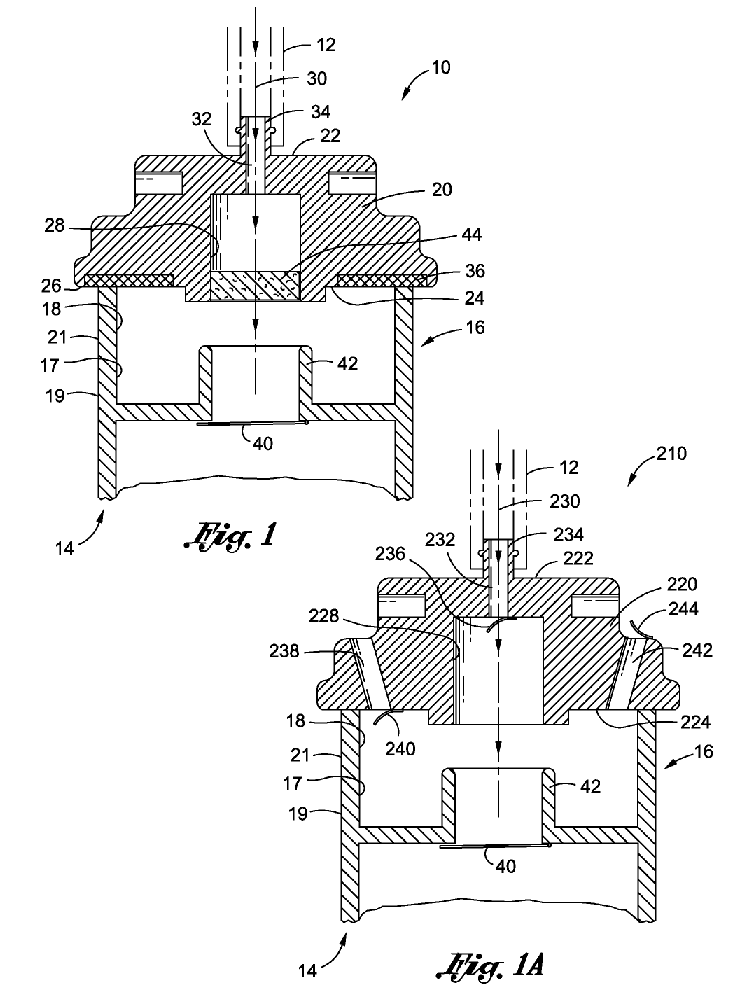

Referring now to the drawings wherein the showings are for purposes of illustrating a preferred embodiment of the present invention only, and not for purposes of limiting the same, FIG. 1 depicts an inlet adapter 10 constructed in accordance with an embodiment of the present invention. The inlet adapter 10 is configured for use with a fluid test device 12 for testing the fluid integrity of a fluid system 14. As used herein, a fluid system 14 may include any system being fluidly sealable designed to have fluid disposable therein. Fluid systems 14 may include, but are not limited to fluid tanks, fluid reservoirs or other containers designed to store or transport fluid. It is understood that the fluid system 14 may include one or more fluid inlets and/or fluid outlets to facilitate the ingress and egress of fluid into and out of the system 14. In this manner, the fluid system 14 may be configured to store or transfer fluid from the fluid inlets to the fluid outlets without leaking fluid. An exemplary fluid system 14 is an automotive gas tank. Conventional gas tanks typically include an inlet for receiving gas. The gas tank may also include an outlet fluidly connected to the automobile engine. Gas may flow from the gas tank to the automobile engine via the outlet. The gas tank is designed to store the fuel until the fuel is needed by the engine. A leak within the gas tank is generally undesirable for both economic and environmental reasons. Therefore, if a leak does exist, it is advantageous to identify the existence of the leak as soon as possible.

To this end, a fluid test device 12 may be used to test the fluid integrity of a fluid system 14. As used herein, the fluid integrity relates to whether the fluid system 14 is retaining the fluid as designed. For instance, the fluid integrity may be compromised by tears or leaks within the walls of the fluid system 14 (e.g. fuel tank wall). Problems may also be caused by a loose fitting or joint fluidly connecting two components included within the fluid system 14.

In order to test the fluid system 14, the fluid test device 12 is typically fluidly connected and sealed to the fluid system 14. Once the test device 12 is fluidly connected to the fluid system 14, smoke, or other colored gas may be delivered into the fluid system 14 from a pressurized container. If there is a tear or leak within the fluid system 14, the smoke or gas will exit the fluid system 14 through the tear, thereby identifying vulnerability within the fluid system 14.

Other testing means may also be used in connection with the inlet adapter 10. For instance, the fluid testing device 12 may be fluidly connected to the fluid system 14 to increase the pressure within the fluid system 14. If the fluid system 14 is not capable of maintaining an increased pressure, this may be an indication that the fluid integrity of the fluid system 14 may be compromised.

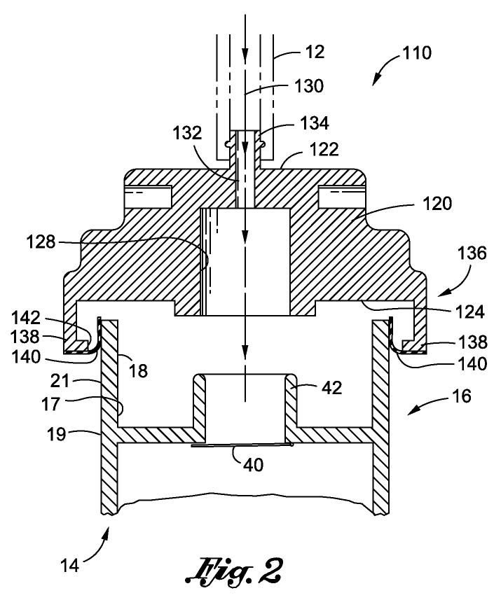

The fluid system 14 includes a primary inlet collar 16 which is fluidly engageable with the fluid test device 12. Many fluid systems 14 include an inlet 42 to allow fluid to be delivered into the fluid system 14. In the embodiments shown in FIGS. 1-2, the inlet 42 includes an inlet valve 40 which closes when fluid is not be delivered into the fluid system 14. The inlet 42 may include an element protruding thereabout which is typically engageable with a cap or seal to close the inlet 42. In the case of a gas tank, there is an opening in the tank through which a conventional gas pump nozzle may be inserted to fill the tank with gas. After the tank has been filled, a cap may be placed over the opening. The gas cap is engageable with a gas inlet collar which is typically an annular protrusion extending around the opening. Such elements protruding about the opening is referred to herein as a primary inlet collar 16. It is understood that the diameter of the annular protrusion extending around the opening of the gas tank may vary from one model to another. It is also contemplated that various fluid systems 14 may not include an element protruding around the opening. In this manner, the primary inlet collar 16 may be defined by the opening defined by the inlet 42.

According to various embodiments, the inlet adapter 10 is configured to create a fluid tight seal over an opening in the fluid system 14 to enable the fluid test device 12 to test the fluid integrity of the fluid system 14. Referring specifically to the embodiment depicted in FIG. 1, the inlet adapter 10 includes an adapter body 20 having an adapter inlet face 22 and an adapter contact face 24. The adapter body 20 also includes an adapter inner wall 28 disposed about an adapter axis 30. The adapter inner wall 28 extends between the adapter inlet face 22 and the adapter contact face 24 to form an adapter channel 32. In this regard, fluid may be communicated between the adapter inlet face 22 and the adapter contact face 24 along the adapter channel 32.

According to one embodiment, the adapter contact face 24 is disposable in contact with the primary inlet collar 16 to form a fluid tight seal with the primary inlet collar 16. The adapter contact face 24 defines a contact face periphery 26 that is circumscribable about the primary collar inner periphery 18. In this manner, the adapter contact face 24 is disposable in contact with the primary inlet collar 16 such that the contact face periphery 26 overlaps the primary collar inner periphery 18. Furthermore, the adapter contact face 24 is disposable in contact with the primary inlet collar 16 to dispose the adapter channel 32 within the primary collar inner periphery 18. In this manner, the adapter channel 32 is in fluid communication with the fluid system 14 when the fluid tight seal is formed between the adapter contact face 24 and the primary inlet collar 16.

As shown, the inlet adapter 10 and the primary inlet collar 16 define circular peripheries 26, 18. Therefore, in order for the inlet adapter 10 to be circumscribable about the primary inlet collar periphery 18, the diameter of the contact face periphery 26 is larger than the diameter of the primary collar inner periphery 18. The circular configuration of the inlet adapter 10 and the primary inlet collar 16 is exemplary in nature only, and is not intended to limit the scope of the present invention.

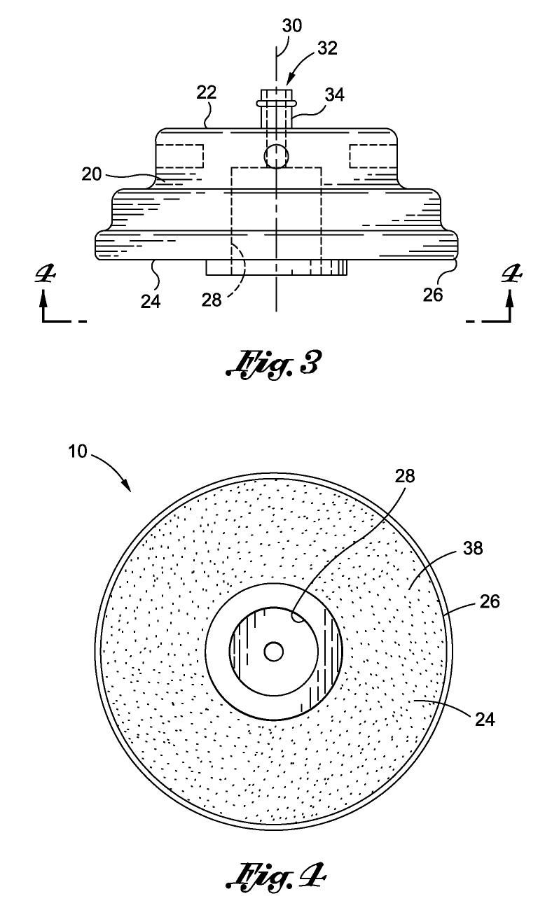

In the embodiment shown in FIGS. 1, 1A, and 3, the inlet adapter 10 is configured to abut an end portion of the primary inlet collar 16. In this manner, the inlet adapter 10 may form an end cap over the primary inlet collar 16 to create a fluid tight seal between the fluid system 14 and the fluid testing device 12.

The inlet adapter 10 may also include one or more attributes for enhancing the fluid tight engagement between the adapter contact face 24 and the primary inlet collar 16. In one particular embodiment, the adapter contact face 24 includes an adhesive 38 disposed thereon, as depicted in FIG. 4. The adhesive 38 mitigates unwanted disengagement of the contact face 24 from the primary inlet collar 16. The adhesive 38 may vary depending on the material of the contact face 24 and the primary inlet collar 16. Furthermore, the adhesive 38 may be applied prior to each use of the inlet adapter 10, or the adhesive 38 may be configured for multiple uses of the inlet adapter 10. In other words, the inlet adapter 10 may repeatedly engage and disengage with the primary inlet collar 16 without reapplying an adhesive 38.

Referring again to the embodiment in FIG. 1, the inlet adapter 10 includes one or more magnets 36 for biasing the contact face 24 into engagement with the primary inlet collar 16. The magnets 36 may be particularly desirable when the primary inlet collar 16 is comprised of a metallic material. The magnets 36 may be connected to the adapter body 20 and exposed along the contact face 24. The magnetic force draws the contact face 24 into engagement with the primary inlet collar 16. Once contact is achieved, the magnetic force biases the contact face 24 against disengagement with the primary inlet collar 16. In other words, in order to disengage adapter body 20 from the primary inlet collar 16, the magnetic force needs to be overcome.

In one particular implementation of the present invention, the magnets 36 are electromagnets capable of creating a magnetic field with the flow of electric current. When the electric current ceases, the magnetic field dissipates. In this regard, the electromagnets are connectable to a power source. The power source may be internal such as a battery, or external such as a power outlet. When the power is on, the magnetic force created by the electromagnet biases the inlet adapter 10 into engagement with the primary inlet collar 16, similar to the magnet 36 described above. However, when the power is off the magnetic force biasing the inlet adapter 10 into engagement with the primary inlet collar 16 may be diminished or nonexistent, in which case the inlet adapter 10 may easily disengage with the primary inlet collar 16.

The electromagnet may be configured to automatically shut off under certain conditions. In this manner, inlet adapter 10 may include an electromagnet control circuit configured to control the amount of current applied to the electromagnet. In one embodiment, the electromagnet control circuit may shut off the electromagnet when the pressure within the fluid system 14 exceeds a predetermined threshold. In this regard, a pressure sensor may be in fluid communication with the adapter channel 32 to measure the pressure therein. When the sensed pressure exceeds the predetermined threshold, the electromagnet control circuit reduces the amount of current received by the electromagnet to reduce or completely remove the magnetic force.

The electromagnet control circuit may also be configured to shut off the electromagnet after a predetermined period of time has elapsed. Therefore, if the inlet adapter 10 inadvertently remains connected to the primary inlet collar 16, the electromagnet control circuit may reduce or completely eliminate the magnetic force created by the electromagnet. In this manner, the electromagnet control circuit is also in operative communication with the power source.

In another embodiment, the engagement between the adapter contact face 24 and the primary inlet collar 16 is enhanced by forming the contact face 24 out of a rubber material. In this regard, the rubber contact face 24 may conform to the shape of the primary inlet collar 16 to create a fluid tight seal as the contact face 24 is pressed against the primary inlet collar 16.

Referring now to the embodiment illustrated in FIG. 1A, there is shown an inlet adapter 230 including an adapter body 220 having multiple channels extending between an adapter inlet face 222 and the adapter contact face 224 in addition to the adapter channel 232. One of the multiple channels is the adapter channel 232, which is defined by an adapter inner wall 228 disposed about an adapter axis 230. The other channels may be used to provide auxiliary inputs and/or exhausts within the inlet adapter 210. For instance, the smoky test fluid may be introduced into the fluid system 14 through the adapter channel 232. However, after a fluid test is complete, it may be desirable to flush the smoke out of the fluid system 14. Therefore, the inlet adapter 210 may include a secondary input channel 238 which is capable of delivering clean air or fluid into the fluid system 14 for purging the smoky fluid from the system 14. To this end, if the fluid system 14 is fully intact, or if the fluid system 14 does not include an exhaust valve which may be opened, it may be desirable to include an exhaust channel 242 in the inlet adapter 210 to allow the smoky air to be exhausted from the fluid system 14.

Each channel 232, 238, 242 may be fitted with a one-way valve to dictate the direction of fluid flow through that particular channel. More specifically, the secondary input channel 238 may include a secondary input valve 240 which may be opened to allow fluid to enter the fluid system 14 through the secondary input channel 238. Likewise, the adapter channel 232 may include an adapter channel valve 236 for allowing fluid to enter the fluid system 14 through the adapter channel 232. The exhaust channel 242 may include an exhaust valve 244 to allow fluid to be exhausted from the fluid system 14 through the exhaust valve 244. It is contemplated that the valves 236, 240, 244 may be one way valves to dictate the flow of fluid through the respective channel. For instance, it may not be desirable to allow fluid to enter the fluid system 14 through the exhaust channel 242. Furthermore, the valves 236, 240, 244 may be locked in a closed position to restrict fluid flow through the particular channel. For instance, it may be desirable to introduce smoke into the fluid system 14 to increase the pressure therein. If the exhaust valve 244 is not locked in a closed position, the smoke may exit through the exhaust channel 242 which may prevent the pressure from increasing from within the fluid system 14.

As previously stated, the fluid test device 12 may introduce smoke or other fluids into the fluid system 14 for purposes of conducting the fluid testing. It is known that smoke may carry particulate matter which may be undesirable in some fluid environments. Therefore, one embodiment of the invention includes a filter 44 for removing some of the particulate matter which may be present in the test fluid and which may be harmful, if introduced into the fluid system 14. The filter 44 may be disposed within the adapter channel 32, as shown in FIG. 1.

According to one aspect of the present invention, inlet adapter 10 is an automotive inlet adapter used to test the fluid integrity of an automotive gas tank. Indeed, the fluid system 14 depicted in FIGS. 1-2 is an inlet portion of a gas tank. The specific primary inlet collar 16 shown is a gas inlet collar defining a gas collar inner periphery. The adapter contact face 24 is disposable in contact with the gas inlet collar to form a fluid tight seal with the gas inlet collar. The adapter contact face 24 defines a contact face periphery that is circumscribable about the gas collar inner periphery. The adapter channel 32 is in fluid communication with the automotive gas tank when the fluid tight seal is formed between the adapter contact face 24 and the gas inlet collar.

The automotive inlet adapter 10 may be used to fluidly couple an automotive fluid test device 12 to an automotive gas tank. It is understood that different car manufacturers install gas inlet collars having different gas collar inner peripheries. If the contact face periphery 26 is not circumscribable about the gas collar inner periphery, a fluid tight seal may not be formed between the automotive inlet adapter 10 and the gas inlet collar. For instance, in one embodiment, the gas inlet collar is cylindrical in nature to define a gas collar outer diameter, and the adapter contact face 24 is circular in nature to define an adapter outer diameter. If the gas collar outer diameter is larger than the adapter outer diameter, the contact face periphery 26 is not circumscribable about the gas collar inner periphery, and a fluid tight seal may not be formed.

Once the automotive inlet adapter 10 is fluidly sealed to the gas inlet collar, and is fluidly connected to the automotive fluid test device 12, the test device 12 is in fluid communication with the automotive gas tank. Therefore, any leaks or tears within the walls of the automotive gas tank which may compromise the fluid integrity thereof may be identified.

Referring now to FIG. 3, there is shown an inlet adapter 110 having a configuration that is slightly different from the inlet adapter 10 described above and illustrated in FIG. 1. In general, the inlet adapter 110 contacts the primary inlet collar 16 in a different manner. The inlet adapter 110 includes an adapter body 120 having an adapter inlet face 122 and an adapter outlet face 124. An adapter inner wall 128 is disposed about an adapter axis 130 and extends between the adapter inlet face 122 and the adapter outlet face 124 to form an adapter channel 132. The inlet adapter 110 also includes an adapter sleeve 136 connected to the adapter body 124. The adapter sleeve 136 is disposable in contact with the primary inlet collar 16 to form a fluid tight seal with the primary inlet collar 16. The adapter channel 134 is in fluid communication with the fluid system 14 when the fluid tight seal is formed between the adapter sleeve 136 and the primary inlet collar 16.

In one embodiment, the adapter sleeve 136 is disposable in contact with the primary collar outer wall 19 to form a fluid tight seal with the primary inlet collar 16. In this regard, the primary inlet collar 16 may be partially received within the inlet adapter 110 to form the fluid tight seal. In another embodiment, the adapter sleeve 136 is disposable in contact with the primary collar inner wall 17 to form the fluid tight seal with the primary inlet collar 16. To this end, the inlet adapter 110 may be partially received within the primary inlet collar 16 to form the fluid tight seal.

According to one implementation, the adapter sleeve 136 includes a flexible adapter seal 140 disposable in contact with the primary inlet collar 16 to form the fluid tight seal therewith. The adapter sleeve 136 includes a rigid portion 138 connected to the adapter body 120. The flexible adapter seal 140 extends between the adaptive sleeve rigid portion 138 and the primary inlet collar 16 when the adapter sleeve 136 is disposed in contact with the primary inlet collar 16. In embodiments where the adapter sleeve 136 engages with the primary collar outer wall 19, the adapter sleeve rigid portion 138 defines an inner sleeve periphery 142 that is circumscribable about the primary collar outer periphery 21. In other words, the primary inlet collar 16 is received within a portion of the inlet adapter 110. The flexible adapter seal 140 extends radially inwardly from the inner sleeve periphery 142 and engages with the primary collar outer wall 19 to form a fluid tight seal therewith.

It is also contemplated that the adapter sleeve 136 may engage with the primary collar inner wall 17 to form the fluid tight seal. In this manner, the adaptive sleeve rigid portion 138 may define an adaptive sleeve outer periphery. The primary collar outer periphery 21 may be circumscribable about the adapter sleeve outer periphery. In this manner, the adapter sleeve 136 may be received within a portion of the primary inlet collar 16. The flexible adapter seal 140 may extend radially outwardly from the outer sleeve periphery to the primary collar inner wall 17 to form the fluid tight seal.

In order to conduct the fluid testing, the inlet adapter 10, 110, 210 may be fluidly connectable to a test device 12. Therefore, various aspects of the present invention include an inlet element 34, 134, 234 connected to the adapter inlet face 22, 122, 222. The inlet element 34, 134, 234 is fluidly connected to the adapter channel 32, 132, 232 and is fluidly connectable to the fluid test device 12. In the embodiments shown, the inlet element 34, 134, 234 is disposed about the adapter axis 30, 130, 230. The fluid test device 12 may include a section of tubing which may be connected to inlet element 34, 134, 234 to facilitate fluid communication between the fluid test device 12 and the inlet adapter 10, 110, 210. Mechanical connectors such as clamps, fittings, joints, or other connectors known by those skilled in the art may also be used.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An inlet adapter for use with a fluid test device for testing the fluid integrity of a fluid system, the fluid system having a primary inlet collar defining a primary collar inner periphery, the inlet adapter comprising:
an adapter body having:
an adapter inlet face;
an adapter contact face disposable in contact with the primary inlet collar to form a fluid tight seal with the primary inlet collar, the adapter contact face defining a contact face periphery being circumscribable about the primary collar inner periphery; and
an adapter inner wall disposed about an adapter axis and extending between the adapter inlet face and the adapter contact face to form an adapter channel, the adapter channel being in fluid communication with the fluid system when the fluid tight seal is formed between the adapter contact face and the primary inlet collar.

2. The inlet adapter as recited in claim 1 further including an inlet element connected to the adapter inlet face, the inlet element being fluidly connected to the adapter channel and fluidly connectable to the fluid test device.

3. The inlet adapter as recited in claim 1 further including a magnet connected to the adapter body, the magnet being magnetically attractable to the primary inlet collar to bias the adapter contact face into fluid tight engagement with the primary inlet collar.

4. The inlet adapter as recited in claim 1 further including an adhesive disposed on the adapter contact face for securing contact between the adapter contact face and the primary inlet collar.

5. The inlet adapter as recited in claim 4 further including a magnet connected to the adapter body, the magnet being magnetically attractable to the primary inlet collar to bias the adapter contact face into fluid tight engagement with the primary inlet collar.

6. The inlet adapter as recited in claim 1 further including an exhaust channel extending between the adapter inlet face and the adapter contact face.

7. The inlet adapter as recited in claim 1 further including a secondary imputer channel extending between the adapter inlet face and the adapter contact face.

8. The inlet adapter as recited in claim 7 further including an exhaust channel extending between the adapter inlet face and the adapter contact face.

9. An inlet adapter for use with a fluid test device for testing the fluid integrity of a fluid system, the fluid system having a primary inlet collar including a primary collar outer wall defining a collar outer periphery, the inlet adapter comprising:
an adapter body including:
an adapter inlet face and an adapter outlet face; and
an adapter inner wall disposed about an adapter axis and extending between the adapter inlet face and the adapter outlet face to form an adapter channel; and
an adapter sleeve connected to the adapter body, the adapter sleeve being disposable in contact with the primary inlet collar to form a fluid tight seal with the primary inlet collar, the adapter channel being in fluid communication with the fluid system when the fluid tight seal is formed between the adapter sleeve and the primary inlet collar.

10. The inlet adapter as recited in claim 9, wherein the adapter sleeve is disposable in contact with the primary collar outer wall to form the fluid tight seal with the primary inlet collar.

11. The inlet adapter as recited in claim 9, wherein the adapter sleeve includes a flexible adapter seal disposable in contact with the primary collar outer wall to form the fluid tight seal with the primary inlet collar.

12. The inlet adapter as recited in claim 11 wherein the adapter sleeve includes a rigid portion connected to the adapter body, the rigid portion defining an inner sleeve periphery being circumscribable about the collar outer periphery.

13. The inlet adapter as recited in claim 12 wherein the flexible adapter seal extends radially inwardly from the inner sleeve periphery.

14. The inlet adapter as recited in claim 9 further including an inlet element connected to the adapter inlet face, the inlet element being fluidly connected to the adapter channel and fluidly connectable to the fluid test device.

15. An automotive inlet adapter for use with an automotive fluid test device for testing the fluid integrity of an automotive gas tank, the automotive gas tank having a gas inlet collar defining a gas collar inner periphery, the automotive inlet adapter comprising:
an adapter body having:
an adapter inlet face;
an adapter contact face disposable in contact with the gas inlet collar to form a fluid tight seal with the gas inlet collar, the adapter contact face defining a contact face periphery circumscribable about the gas collar inner periphery; and
an adapter inner wall disposed about an adapter axis and extending between the adapter inlet face and the adapter contact face to form an adapter channel, the adapter channel being in fluid communication with the automotive gas tank when the fluid tight seal is formed between the adapter contact face and the gas inlet collar.

16. The automotive inlet adapter as recited in claim 15 further including an inlet element connected to the adapter inlet face, the inlet element being fluidly connected to the adapter channel and fluidly connectable to the fluid test device.

17. The automotive inlet adapter as recited in claim 15 further including a magnet connected to the adapter body, the magnet being magnetically attractable to the primary inlet collar to bias the adapter contact face into fluid tight engagement with the primary inlet collar.

18. The automotive inlet adapter as recited in claim 15 further including an adhesive disposed on the adapter contact face for securing contact between the adapter contact face and the primary inlet collar.

19. The automotive inlet adapter as recited in claim 18 further including a magnet connected to the adapter body, the magnet being magnetically attractable to the primary inlet collar to bias the adapter contact face into fluid tight engagement with the primary inlet collar.

20. The automotive inlet adapter as recited in claim 15 further including an exhaust channel extending between the adapter inlet face and the adapter contact face.
